(19) United States
(12) Patent Application Publication
(10) Pub. No.: US 2023/0011934 A1
(43) Pub. Date: Jan. 12, 2023

(54) CONTAINER SYSTEM WITH A REMOVABLE CAP

(71) Applicant: Jeremiah Buck, Denver, CO (US)

(72) Inventor: Jeremiah Buck, Denver, CO (US)

(21) Appl. No.: 17/860,433

(22) Filed: Jul. 8, 2022

Related U.S. Application Data
(60) Provisional application No. 63/219,618, filed on Jul. 8, 2021.

(51) Int. Cl. B65D 50/04; B65D 41/34; B65D 51/32

(52) U.S. Cl. CPC B65D 50/043; B65D 41/34; B65D 51/32; B65D 2215/02

(57) ABSTRACT

Storage and dispensing systems are provided. In various embodiments, systems of the present disclosure provide safety feature to prevent or limit the risk of a child or minor opening the system. Embodiments of the present disclosure further comprise novel cap and closure arrangements including, for example, features that are operable to automatically load or fill a pipette of the system.

This U.S. Non-Provisional Patent application claims the benefit of priority from U.S. Provisional Patent Application Ser. No. 63/219,618, filed Jul. 8, 2021, the entire disclosure of which is hereby incorporated by reference.

### FIELD

Embodiments of the present disclosure relate to containers and closure mechanisms. More specifically, embodiments of the present disclosure are related to container systems that have a removable, preferably-childproof cap and/or a self-loading mechanism for loading contents into a dropper or pipette.

### BACKGROUND

Containers have long been used to store loose objects as well as consumable goods within a volume or recess of the container. A lid or cap can cover the volume or recess for storage of the objects or goods. One concern with some containers is the accidental consumption of contents within the container by, for example, a child. Up to 300 children are poisoned per day in the United States, mostly due to the accidental ingestion of hazardous materials, which includes goods such as medication stored in a container. This issue has not gone unnoticed as some containers have childproof features. Prescription bottles often have a childproof cap that requires a two-part process to remove the cap from the container. First, the cap is pressed downward against the container, and then the cap is rotated relative to the container to remove the cap from the container. The vast majority of children will not appreciate the two-part opening process for removing the cap and/or will not have the dexterity for the two-part opening process.

Another example of a childproof cap used for over-the-counter goods is a cap that requires a specific rotational alignment between the cap and the container before the cap can be pulled from the container to access the goods within the container. A discrete marking on the cap and a discrete marking on the container can indicate the proper rotational alignment. Again, the vast majority of children will not appreciate the markings and/or two-part process to remove the cap. One issue with these existing childproof caps is the complex shapes of the caps and respective features such as markings on the containers that necessitate an expensive manufacturing process such as injection molded plastic. This greatly increases the costs to produce the container and removable cap.

Another issue with existing childproof caps is the use of materials such as plastic to produce the complex shapes. Every year, eight million metric tons of plastic waste enters the world's oceans in addition to the 150 million metric tons of plastic waste already in the oceans. Moreover, plastics are typically only recyclable a few times before the physical properties of the plastic material degrade so much that the plastic material is not usable. Therefore, there is a need for a container and cap that are simple, cheap to manufacture, recyclable and yet childproof to prevent accidental consumption or handling of objects or goods stored in the container.

Additionally, droppers for storing and dispensing relatively small amounts of liquid are known. Such droppers are occasionally referred to as “Pasteur pipettes” and can comprise a bottle or similar container with a combination lid and tube having a deformable bulb for creating a vacuum and loading contents (e.g. liquid) from a container into the tube. Known devices generally fail to provide self-loading or auto-loading features as shown and described herein, which reduce the number of steps required by a user to fill or charge a pipette for use.

### SUMMARY

As used herein, the terms “dropper”, “pipette”, “eye dropper”, and “Pasteur pipette” are all generally assumed to refer to the same device. Embodiments of the present disclosure contemplate droppers and improvements thereto. While various embodiments provide droppers and related features, it should be recognized that the present disclosure is not limited to use with droppers. For example, it is contemplated that various features provided herein related to auto-loading mechanisms and child-safety features are useful with devices and applications other than droppers including, for example, lids and closures without a pipette.

It is also contemplated that containers of the present disclosure are not limited to use with any particular substance. For example, various embodiments of the present disclosure are contemplated for use with medicaments (e.g. eyedrops) or oils (e.g. cosmetics or cannabidiol) but the devices, features and concepts disclosed herein are not limited to use with such substances.

It is an object of the present disclosure to provide a dropper with a self-loading or auto-loading feature. As used herein, the terms “self-loading” and “auto-loading” are both intended to refer to a system wherein the steps required of a user to fill or load a tube of a pipette are reduced or minimized. In some embodiments, a device is provided that comprises the ability to perform an automatic suction operation to charge a dropper. In some embodiments, a closing or threading action wherein a cap comprising a pipette is applied to a bottle causes a bulb of the device to be depressed. This action expunges fluid from the pipette, and the bulb is retained in this position while the device remains closed. An opening or un-threading action is operable to remove a force from the bulb which draws fluid housed within the bottle into the pipette in an automated fashion such that a separate action of filling the pipette is not required. In such embodiments, the action of opening or un-threading the cap charges or fills the pipette with contents from the bottle and the device is prepared for use.

In various embodiments, childproof container systems are provided. Such systems are contemplated as being provided in combination with self-loading or auto-loading features but may also be provided in isolation. In some embodiments, systems comprise a first cap member comprising teeth and a second cap member comprising corresponding teeth operable to interface with the first cap member. The sets of teeth are initially spaced apart such that depression and rotation of at least a portion of the cap is required for the teeth to mate and cause a rotation of threaded portions of the device.

In one embodiment, a storage and dispensing system for fluids is provided. The system comprises a container comprising a first internal volume. A pipette is provided that comprises a second internal volume that is less than the first internal volume, and the pipette is operable to at least partially extend into the first internal volume at least when the system is a closed position. The pipette comprises an open distal end and a proximal end comprising a pliable bulb. A cap member is provided in communication with the proximal end of the pipette. An actuatable member that is moveable relative to the cap member and operable to contact the pliable bulb is provided, and the cap member comprises at least one of a ramp and a cam operable to apply a force to a portion of the actuatable member. The ramp or cam is preferably provided on an interior surface of a portion of the cap member such that it is not visible or accessible to a user. The ramp or camp is operable to convert rotational motion of a portion of the cap to a linear motion of the actuatable member and/or pliable bulb. The storage and dispensing system can have two components that are a threaded member having teeth at an upper end and an inner cap having teeth at a lower end, and the actuatable member has a protrusion that extends into a slot of the inner cap such that the actuatable member is moveable relative to the inner cap of the cap member. Moreover, the threaded member has a threaded inner surface at a lower end, and the threaded inner surface complements a threaded outer surface on the container to apply or remove the cap member from the container. In some embodiments, a ridge extends from an outer surface of the actuatable member, and the at least one of a ramp and a cam acts on the ridge to apply the force to the actuatable member. In various embodiments, the cap member has two of a ramp and a cam equally spaced about an inner surface of the cap member.

One particular embodiment of the present disclosure is a cap system for use with a container, comprising an inner cap having an inner surface that defines an interior volume, the inner cap having a slot extending through an outer surface to the inner surface; a button at least partially disposed in the interior volume of the inner cap, the button having a ridge extending from an outer surface of the button and having a protrusion extending from the outer surface of the button into the slot of the inner cap such that the button can move relative to the inner cap along a longitudinal axis; a pliable bulb at least partially disposed within the button, wherein the bulb is compressible from a first volume to a smaller second volume; and an outer cap disposed about the inner cap, the outer cap having a cam surface extending from an inner surface of the outer cap, wherein rotation of the outer cap relative to the inner cap moves the cam surface into the ridge of the button and drives the button along the longitudinal axis relative to the inner cap, which causes the button to compress the bulb from the first volume to the smaller second volume.

In some embodiments, the system further comprises a threaded member disposed within the outer cap, the threaded member having teeth at an upper end that selectively engage teeth at a lower end of the inner cap, wherein, with the teeth engaged, rotation of the inner cap rotates the threaded member to selectively engage and disengage the threaded member from the container. In various embodiments, the threaded member comprises a threaded inner surface at a lower end, wherein the threaded inner surface is configured to complement a threaded outer surface of the container. In some embodiments, a force acting on the outer cap along the longitudinal axis drives the outer cap into the inner cap, and the teeth on the inner cap engage the teeth on the threaded member.

In various embodiments, the system further comprises a pipette in fluid communication with the pliable bulb, wherein fluid is expelled from the pipette as the pliable bulb compresses from the first volume to the smaller second volume. In some embodiments, a force acting on the button in the longitudinal direction drives the button into the pliable bulb to compress the pliable bulb from the first volume to the smaller second volume. In various embodiments, rotation of the outer cap in an opposing direction relative to the inner cap moves the cam surface off of the ridge, which allows the pliable bulb to expand from the smaller second volume to the first volume, and the pliable bulb drives the button along the longitudinal axis relative to the inner cap.

Another particular embodiment of the present disclosure is a cap system for use with a container, comprising an outer cap having an interior volume; a threaded member positioned in the interior volume of the outer cap, the threaded member having a threaded inner surface at a lower end and having a plurality of teeth at an upper end; an inner cap positioned in the interior volume of the outer cap, the inner cap having a plurality of teeth at a lower end of the inner cap, wherein the inner cap is freely rotatable relative to the threaded member until a sufficient force is applied to the outer cap along a longitudinal axis, and the outer cap contacts the inner cap to cause the plurality of teeth of the inner cap to engage the plurality of teeth of the threaded member such that the threaded inner surface of the threaded member can selectively engage and disengage from a threaded outer surface of the container; a pliable bulb at least partially positioned in the interior volume of the outer cap; and a pipette in fluid communication with the pliable bulb, wherein the pliable bulb is compressible to move fluid out of the pipette and into the container, and the pliable bulb is expandable to move fluid from the container and into the pipette.

In some embodiments, the system further comprises a button disposed about the pliable bulb, wherein movement of the button along the longitudinal axis in a first direction causes the pliable bulb to compress from a first volume to a second volume and move fluid out of the pipette and into the container. In various embodiments, in a manual mode of operation, a longitudinal force acts on the button to cause the button to move along the longitudinal axis in the first direction and move fluid out of the pipette and into the container.

In some embodiments, the button has a ridge extending from an outer surface, and the outer cap has a cam extending from an inner surface, wherein rotation of the outer cap about the longitudinal axis causes the cam to engage the ridge and the button to move along the longitudinal axis. In various embodiments, in an auto-loading mode of operation, a first longitudinal force acts on the outer cap to cause the plurality of teeth of the inner cap to engage the plurality of teeth of the threaded member, and a first rotational force acts on the outer cap to drive the cam into the ridge, move the button along the longitudinal axis in the first direction, and move fluid out of the pipette and into the container, and the first rotational force causes the threaded inner surface of the threaded member to engage the threaded outer surface of the container.

In some embodiments, in the auto-loading mode of operation, a second longitudinal force acts on the outer cap to cause the plurality of teeth of the inner cap to engage the plurality of teeth of the threaded member, and a second rotational force acts on the outer cap to back the cam off of the ridge to allow the pliable bulb to expand, move the button along the longitudinal axis in a second direction, and move fluid from the container and into the pipette, and the second rotational force causes the threaded inner surface of the threaded member to disengage the threaded outer surface of the container.

The Summary is neither intended nor should it be construed as being representative of the full extent and scope of the present disclosure. Embodiments are set forth in various levels of detail in the Summary as well as in the attached drawings and the Detailed Description and no limitation as to the scope of the present disclosure is intended by either the inclusion or non-inclusion of elements or components. Additional aspects of the container system and methods of use will become more readily apparent from the Detailed Description, particularly when taken together with the drawings.

The above-described embodiments, objectives, and configurations are neither complete nor exhaustive. As will be appreciated, other embodiments are possible using, alone or in combination, one or more of the features set forth above or described in detail below.

The phrases “at least one,” “one or more,” and “and/or,” as used herein, are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves.

### BRIEF DESCRIPTION OF THE DRAWINGS

The accompanying drawings, which are incorporated in and constitute a part of the specification, illustrate embodiments of the container system and together with the Summary given above and the Detailed Description of the drawings given below, serve to explain the principles of these embodiments. In certain instances, details that are not necessary for an understanding of the container system or that render other details difficult to perceive may have been omitted. It should be understood, of course, that the container system is not necessarily limited to the particular embodiments illustrated herein. Additionally, it should be understood that the drawings are not necessarily to scale.

FIG. 1 is a perspective view of a container and dropper.

FIG. 2 is a perspective view of a container and a dropper according to an embodiment of the present disclosure.

FIG. 3 is an exploded perspective view of a container and a dropper according to one embodiment of the present disclosure.

FIG. 4 is an elevation view of a container and dropper with certain features removed for illustrative purposes.

FIG. 5 is a cross-sectional elevation view of a container and a dropper according to one embodiment of the present disclosure.

FIG. 6 is a cross-sectional elevation view of a container and a dropper according to one embodiment of the present disclosure.

FIG. 7 is a cross-sectional elevation view of a container and a dropper according to one embodiment of the present disclosure.

Similar components and/or features may have the same reference label. Further, various components of the same type may be distinguished by following the reference label by a letter that distinguishes among the similar components. If only the first reference label is used, the description is applicable to any one of the similar components having the same first reference label irrespective of the second reference label.

### DETAILED DESCRIPTION

The container system has significant benefits across a broad spectrum of endeavors. It is the Applicant's intent that this specification and the claims appended hereto be accorded a breadth in keeping with the scope and spirit of the disclosure despite what might appear to be limiting language imposed by the requirements of referring to the specific examples disclosed. To acquaint persons skilled in the pertinent arts, a preferred embodiment that illustrates the best mode now contemplated for putting the container system into practice is described herein by, and with reference to, the annexed drawings that form a part of the specification. The exemplary embodiment is described in detail without attempting to describe all of the various forms and modifications in which the container system might be embodied. As such, the embodiments described herein are illustrative, and as will become apparent to those skilled in the arts, may be modified in numerous ways within the scope and spirit of the disclosure.

Although the following text sets forth a detailed description of numerous different embodiments, it should be understood that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning.

Various embodiments are described herein and as depicted in the drawings. It is expressly understood that although the figures depict container systems, caps, and methods and systems for using the same, the present disclosure is not limited to these embodiments.

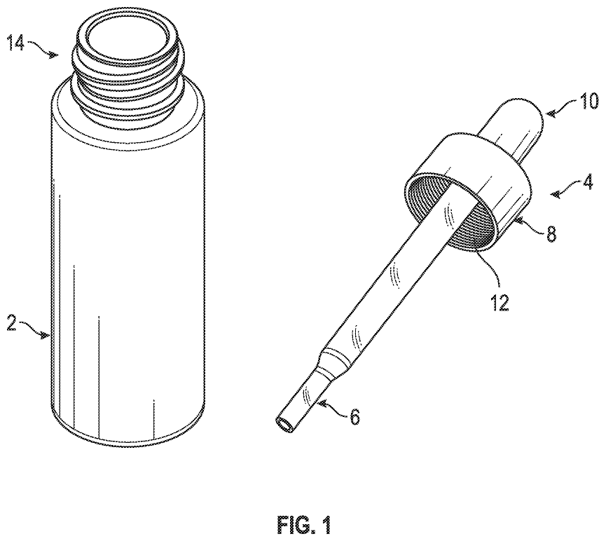

Referring now to FIG. 1, a storage system is shown that comprises a container 2 or bottle and a combination cap and dropper 4. The container 2 is contemplated as comprising a bottle of various materials, sizes, etc. A glass bottle is shown, but containers 2 of the present disclosure are not limited to any particular material or size. A dropper 4 is provided that comprises a pipette 6, a cap 8 and a bulb 10. The cap 8 is contemplated as comprising internal threads 12 that correspond and mate with external threads 14 on the container 2. The cap and dropper 4 provide the dual purposes of closing or securing the bottle and providing a dispensing apparatus. When the cap 8 is secured to the bottle it provides a closure mechanism for the bottle. When the cap 8 is removed from the bottle, the bulb 10 and pipette 6 are operable to serve as a dropper-type dispensing apparatus. Fluid (including but not limited to air) can be purged from the pipette by applying a force to the bulb 10. The bulb 10 preferably comprises an elastic element with an inherent restoring force. Accordingly, removing a force from the bulb 10 provides a suction force or pressure differential that is operable to draw fluid (including but not limited to liquid from the container 2) into the pipette. The fluid can then be dispensed as desired by applying a force to the bulb. This process is repeatable.

The embodiment of FIG. 1 is a conventional system. A first action is required in order to remove the cap 8 and pipette 6 from the container 2. Additional, subsequent action is required to then load the pipette 6 and draw fluid into the pipette 6.

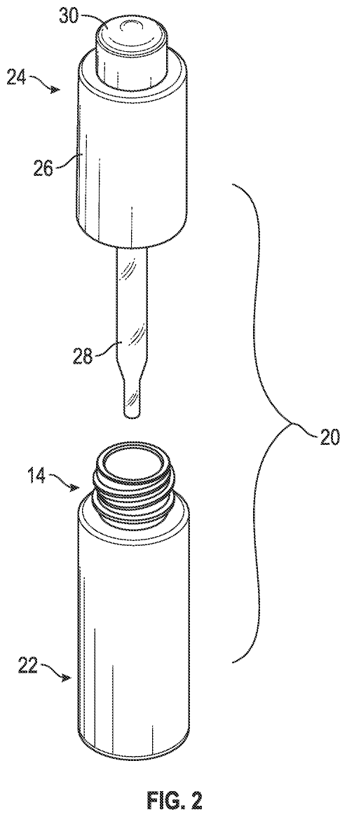

FIG. 2 depicts an embodiment of the present disclosure wherein loading of the pipette is provided in an automated or self-loading process. As shown in FIG. 2, a container system 20 is provided that comprises a container 22 and a closure member 24. The closure member 24 comprises a combined cover and dispensing device as will be shown and described. The closure member 24 comprises a pipette 28 for selectively dispensing a liquid (for example). A button 30 is provided that covers and communicates with a bulb (not shown in FIG. 2) and an outer cap 26. The closure member 24 preferably comprises safety features including, for example, child-lock features as shown and described herein.

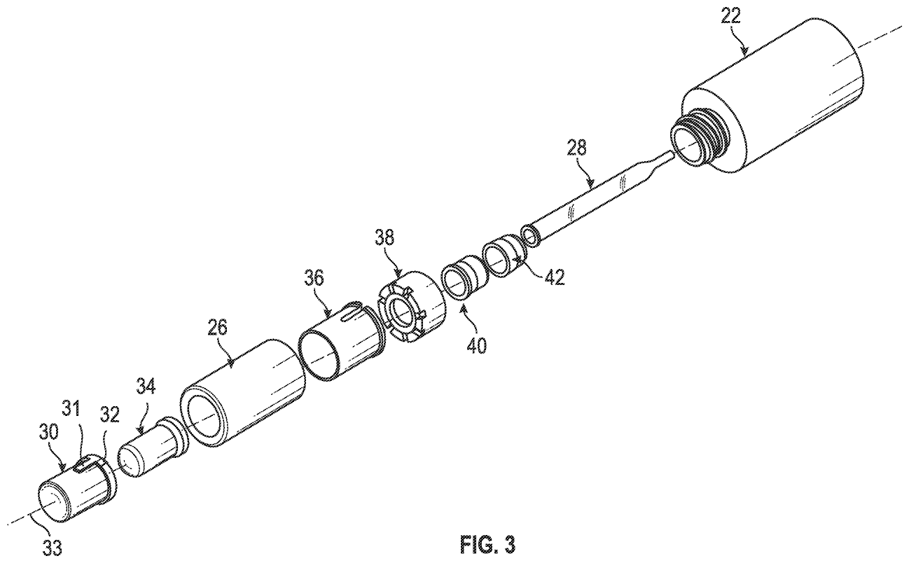

FIG. 3 is an exploded perspective view of a container system 20 according to an embodiment of the present disclosure with various components arranged along a longitudinal axis 33. As shown, a container 22 is provided. A closure member is provided that comprises a combination lid and dispensing device. The lid and dispensing system comprises a pipette 28 is provided that is operable to extend into the container 22 at least when the device is in an assembled or closed position. The pipette comprises an internal volume, a tapered distal end and an open proximal end. The pipette 28 is operable to house and store fluid and dispense the same in a controlled and predictable manner.

An outer cap 26 is provided that is operable to communicate with additional components as shown and described herein. A bulb 34 is disposed partially within the outer cap, and the bulb 34 is actuated by a button 30 which is accessible to a user. The button 30 in this embodiment has both a ridge 31 and a protrusion 32 extending from an outer surface. An inner cap 36 is provided and is disposed at least partially within the outer cap in an assembled state. A threaded member 38 is provided that is operable to communicate with threads of the bottle 22. The threaded member 38 comprises teeth at a proximal end thereof to selectively communicate with the inner cap 36 and related components. In the depicted embodiment, an axial or longitudinal force must be provided to place the inner cap 36 in communication with the threaded member 38 and impart a rotation force. This arrangement provides a safety or “child-lock” feature wherein rotation of the outer cap 26 (for example) alone will not result in an un-threading or removal of the closure member from the bottle. A rotational motion must be provided in combination with an axial or longitudinal force in order to remove the closure and dispensing device from the container 22. Seals 40, 42 are provided to secure the bulb 34 to the pipette 28 and to provide a secure closure of the container 22.

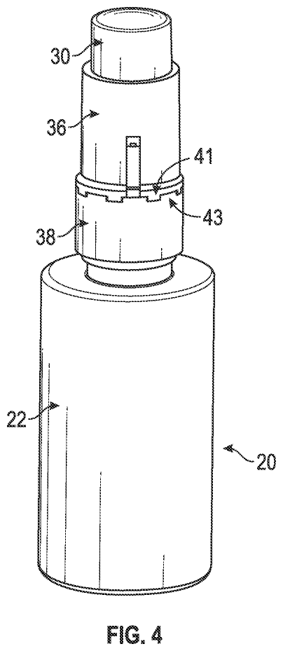

FIG. 4 is an elevation view of a container and dispensing system 20 according to one embodiment of the present disclosure. Various components have been removed in FIG. 4 for illustrative purposes and to assist in depicting the safety features of the device. As shown, the system 20 comprises a container 22 and a closure member. The closure member comprises a plurality of components including, for example, an inner cap 36 and a threaded member 38. A button 30 protrudes from the inner cap 36 and is operable to provide a force upon a bulb (not shown in FIG. 4, but see 34 in FIG. 3) to operate a pipette. As shown in FIG. 4, the teeth 41 of the inner cap 36 are provided in force-transmitting communication with the teeth 43 of the threaded member 38. In this arrangement, a force applied to the outer cap and/or inner cap 36 is operable to impart force and rotation upon the threaded member 38 and thus secure or remove the cap from the container 22. In a second configuration (not shown in FIG. 4), the inner cap 36 is spaced apart from the threaded member 38 such that the teeth of the related features are not in contact with one another and rotation of the outer cap and/or inner cap does not apply force to the threaded member 38. Additionally, the outer cap (26 in FIG. 3) provides a shroud or cover member that substantially prevents contact with the threaded member 38 such that the threaded member 38 cannot be rotated independently of the outer cap and/or inner cap 36.

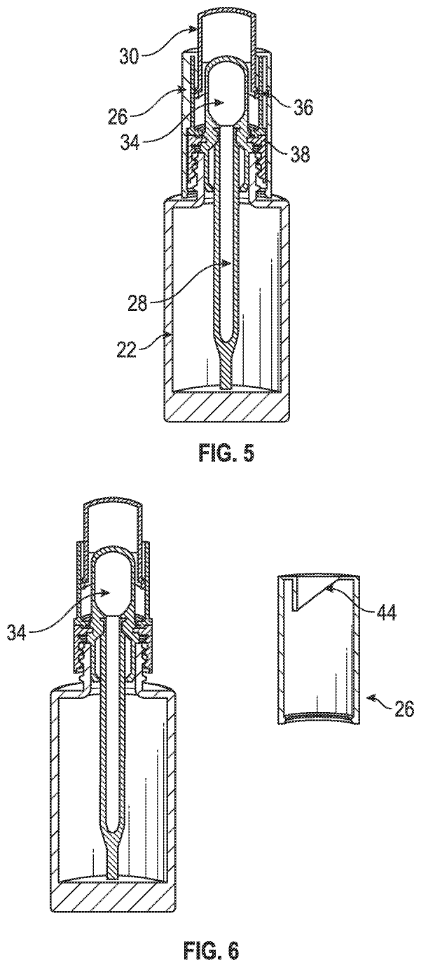

FIG. 5 is a cross-sectional elevation view of a container and dispensing system according to one embodiment of the present disclosure. As shown, a container 22 is provided that comprises an internal volume for storing contents. A closure member is provided that comprises a pipette 28. The pipette 28 extends into the internal volume of the container at least when the system is provided in a closed position. A tapered distal end of the pipette is preferably provided at or proximal to a lowermost portion of the internal volume of the container 22 where it is capable of drawing fluid regardless of a fill level of the container 22.

In the assembled state shown in FIG. 5, the closure and dispensing member comprises a button 30 that is operable to contact a bulb 34 to operate the pipette 28. The button 30 is operable to control and actuate the bulb 34 is a conventional manner. Specifically, the button 30 may be selectively depressed by a user to purge fluid and pressure from the bulb 34 and pipette 28. Releasing the button 30 allow the bulb 34 to restore its original position and draw fluid (e.g. air, liquid, oil, etc.) into the pipette. Additionally, and as will be shown and described in more detail herein, the interaction of various components of the present disclosure are operable to “auto-fill” a pipette 28 by transferring force to the bulb 34. In some embodiments, a twisting or threading motion of the threaded member 38 and outer cap 26 transfers a force to the bulb 34 such that the system is closed and the bulb is depressed. This action purges the bulb 34 and pipette 28 of contents. When the cap is unthreaded or removed, force or pressure is removed from the bulb, thereby allowing it to regain its original unbiased position and create a pressure differential that “automatically” draws contents from the container 22 into the pipette 28. In contrast with known devices, embodiments of the present disclosure do not need to be opened and then subsequently filled or charged.

FIG. 6 is a cross-sectional elevation view of an embodiment of the present disclosure and wherein the outer cap 26 has been removed for illustrative purposes. As shown in FIG. 6, a system is provided that comprises a container 22, a pipette 28, a bulb 34, a threaded member 38, an inner cap 36, and a button 30 as described with respect to FIG. 5. The outer cap 26 of various embodiments of the present disclosure comprises a ramp or cam 44. The cam 44 is operable to impart a force upon additional components and to convert a rotational motion of the outer cap 26 to a linear force to be applied to the bulb 34 (for example). The button 30 of the depicted embodiment comprises a ridge (see 31 in FIG. 3) extending from an outer surface of the button. As the outer cap 26 rotates, the cam 44 progressively drives the button 30 downward by contact with the ridge, until the button is fully depressed against the pliable bulb 34. This action evacuates excess fluid (e.g. air) from the pipette 28. The button preferably remains in the depressed position while the lid is on the container. As the lid is removed and the outer cap 26 rotates in the opposite direction, contact between the cam is withdrawn and the bulb 34 returns to its expanded position. Fluid is thus drawn from the container 22 into the pipette 28. This relationship automatically “loads” the pipe with fluid as the lid is removed from the container. Accordingly, the dispensing device including the pipette is ready for use as soon as it is removed from the container 22.

In various embodiments, it is contemplated that the outer cap 26 is secured to the inner cap 36. Accordingly, rotation and linear movement of the inner cap 36 is achieved whenever the same motion is provided to the outer cap 26. In various embodiments, the inner cap 36 is not accessible to a user and the movement of the inner cap is achieved by contacting and manipulating the outer cap 26.

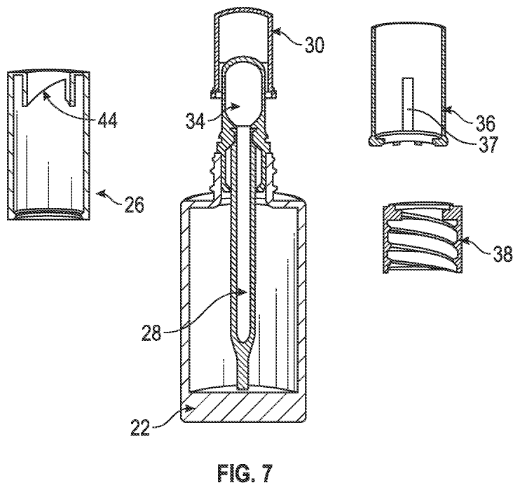

FIG. 7 is an exploded cross-sectional elevation view of an embodiment of the present disclosure. As shown, various components and features have been separated for illustrative purposes. As shown, an outer cap 26 is provided. The outer cap 26 comprises a cam 44 that is operable to contact and apply force to additional components when the outer cap 26 is rotated. In some embodiments, the cam 44 applies a force and drives a button 30 is disposed around and in communication with a bulb 34. An inner cap 36 is provided within the outer cap 26. The inner cap comprises at least one slot 37 in which a protrusion (see 32 in FIG. 6) of the button 34 is disposed such that the button is capable of translating axially or longitudinally with respect to the inner cap 36. The inner cap 36 is moveable relative to a threaded member 38. The inner cap 36 and the threaded member 38 comprises teeth such that when these components are pressed together, rotation of the threaded member 38 is enabled.

In some embodiments, the inner cap 36 is biased upwardly or away from the threaded member 38. In certain embodiments, a coil or leaf spring is provided as being provided to bias and separate the inner cap and the threaded member and prevent contact between these two elements unless and until a force is applied. In other embodiments, the inner cap is not biased by a biasing element (e.g. spring), but a force is required to mate the two elements and achieve rotation of the threaded member 38.

In some embodiments, the outer cap 26 and the inner cap 36 are in communication such that they are rotationally fixed relative to one another. The inner cap 36 is preferably displaceable in an axial or longitudinal direction relative to the outer cap 26 but are rotationally fixed such that they co-rotate (when the outer cap is rotated, for example). The threaded member 38 is rotatable within and relative to the outer cap 26 at least when the teeth of the inner cap 36 and the threaded member are not engaged. Upon placing the inner cap 36 in communication with the threaded member 38, the outer cap 26, the inner cap 36 and the threaded member 38 are operable to rotate together. As previously discussed, the cam 44 of the outer cap 26 contacts and drives the button 30 which is axially or longitudinally displaceable within the inner cap 36. This displacement allows for a threaded closing of the container and simultaneous purging and depressing of the bulb 34. The system is thus provided in a closed position with the bulb being depressed. Reverse rotation is then provided to open the container, whereupon external pressure is removed from the bulb 34, allowing the pipette 28 to draw fluid in such that the device is automatically prepared for use.

Thus, embodiments of the cap system described herein can function in various modes of operation. In a manual mode of operation, a longitudinal force acts on the button 30 and drives the button 30 in a first direction along the longitudinal axis 33 (see FIG. 3) into the pliable bulb 34 to compress the pliable blub 34 and drive any fluid out of the pipette 28 and into the container 22. When the longitudinal force is removed from the button 30, the pliable bulb 34 expands, which draws in fluid from the container 22 into the pipette 28. The expansion of the pliable bulb 34 also moves the button 30 in a second direction along the longitudinal axis 33 away from the other components of the cap system. In this sense, direct, manual actuation of the button 30 operates the pliable bulb 34 and pipette 28 like an eyedropper.

The cap system may also function in an auto-loading mode of operation. In this mode, a longitudinal force acts on the outer cap 26, which drives the outer cap 26 into the inner cap 36 along the longitudinal axis 33 and also causes the teeth of the inner cap 36 to engage the teeth of the threaded member 38. Next, a rotational force acts on the outer cap 26. In the depicted embodiment, the rotational force acts in a clockwise direction about the longitudinal axis 33 when viewed from above. The rotational movement of the outer cap 26 drives a cam of the outer cap 26 into a ridge of the button 30, causing the button 30 to move along the longitudinal axis 33 in a first direction to compress the pliable bulb 34 and drive any fluid out of the pipette 28 and into the container 22. The rotational movement of the outer cap 26 is also translated to the inner cap 36, which, through engagement of the teeth, causes the threaded inner surface of the threaded member 38 to screw onto the threaded outer surface of the container 22. Once in this closed position, the container 22 and cap system can be stored with the pliable bulb 34 purged.

When use of the cap system and the contents of the container 22 is desired, a longitudinal force again acts on the outer cap 26 for teeth engagement, and a rotational force acts on the outer cap 26. This time, the rotational force acts in a counterclockwise direction about the longitudinal axis 22 when viewed from above. Thus, the threaded member 38 is unscrewed from the container 22, and the cam of the outer cap 26 backs off of the ridge of the button 30. This allows the pliable bulb 34 to expand and draw in fluid from the container 22 into the pipette 28 as the cap system is removed from the container 22. Thus, the pipette 28 is automatically loaded with fluid as the cap system is removed from the container 22.

The description of the container system has been presented for purposes of illustration and description but is not intended to be exhaustive or limiting of the container system to the form disclosed. Many modifications and variations will be apparent to those of ordinary skill in the art. The embodiments described and shown in the figures were chosen and described in order to best explain the principles of the container system, the practical application, and to enable those of ordinary skill in the art to understand the container system.

While various embodiments have been described in detail, it is apparent that modifications and alterations of those embodiments will occur to those skilled in the art. Moreover, references made herein to “the container system” or aspects thereof should be understood to mean certain embodiments of the container system and should not necessarily be construed as limiting all embodiments to a particular description. It is to be expressly understood that such modifications and alterations are within the scope and spirit of the present disclosure, as set forth in the following claims.

What is claimed is:

1. A storage and dispensing system for fluids, the system comprising:
a container comprising a first internal volume;
a pipette comprising a second internal volume that is less than the first internal volume, and wherein the pipette is operable to at least partially extend into the first internal volume when the system is in a closed position;
the pipette comprising an open distal end and a proximal end comprising a pliable bulb;
a cap member in communication with the proximal end of the pipette;
an actuatable member that is moveable relative to the cap member and operable to contact the pliable bulb; and
wherein the cap member comprises at least one of a ramp and a cam operable to apply a force to a portion of the actuatable member.

2. The storage and dispensing system of claim 1, wherein two components of the cap member comprise teeth that must be brought into communication to apply or remove the cap member from the container.

3. The storage and dispensing system of claim 2, wherein the two components are a threaded member having teeth at an upper end and an inner cap having teeth at a lower end, and the actuatable member has a protrusion that extends into a slot of the inner cap such that the actuatable member is moveable relative to the inner cap of the cap member.

4. The storage and dispensing system of claim 3, wherein the threaded member has a threaded inner surface at a lower end, and the threaded inner surface complements a threaded outer surface on the container to apply or remove the cap member from the container.

5. The storage and dispensing system of claim 1, wherein the at least one of a ramp and a cam is provided on an internal surface of the cap member and is operable to apply a force to the actuatable member to operate the pliable bulb.

6. The storage and dispensing system of claim 1, wherein a ridge extends from an outer surface of the actuatable member, and the at least one of a ramp and a cam acts on the ridge to apply the force to the actuatable member.

7. The storage and dispensing system of claim 1, wherein the cap member comprises two of a ramp and a cam equally spaced about an inner surface of the cap member.

8. A cap system for use with a container, comprising:
an inner cap having an inner surface that defines an interior volume, the inner cap having a slot extending through an outer surface to the inner surface;
a button at least partially disposed in the interior volume of the inner cap, the button having a ridge extending from an outer surface of the button and having a protrusion extending from the outer surface of the button into the slot of the inner cap such that the button can move relative to the inner cap along a longitudinal axis;
a pliable bulb at least partially disposed within the button, wherein the bulb is compressible from a first volume to a smaller second volume; and
an outer cap disposed about the inner cap, the outer cap having a cam surface extending from an inner surface of the outer cap, wherein rotation of the outer cap relative to the inner cap moves the cam surface into the ridge of the button and drives the button along the longitudinal axis relative to the inner cap, which causes the button to compress the bulb from the first volume to the smaller second volume.

9. The cap system of claim 8, further comprising a threaded member disposed within the outer cap, the threaded member having teeth at an upper end that selectively engage teeth at a lower end of the inner cap, wherein, with the teeth engaged, rotation of the inner cap rotates the threaded member to selectively engage and disengage the threaded member from the container.

10. The cap system of claim 9, wherein the threaded member comprises a threaded inner surface at a lower end, wherein the threaded inner surface is configured to complement a threaded outer surface of the container.

11. The cap system of claim 9, wherein a force acting on the outer cap along the longitudinal axis drives the outer cap into the inner cap, and the teeth on the inner cap engage the teeth on the threaded member.

12. The cap system of claim 8, further comprising a pipette in fluid communication with the pliable bulb, wherein fluid is expelled from the pipette as the pliable bulb compresses from the first volume to the smaller second volume.

13. The cap system of claim 8, wherein a force acting on the button in the longitudinal direction drives the button into the pliable bulb to compress the pliable bulb from the first volume to the smaller second volume.

14. The cap system of claim 8, wherein rotation of the outer cap in an opposing direction relative to the inner cap moves the cam surface off of the ridge, which allows the pliable bulb to expand from the smaller second volume to the first volume, and the pliable bulb drives the button along the longitudinal axis relative to the inner cap.

15. A cap system for use with a container, comprising:
an outer cap having an interior volume;
a threaded member positioned in the interior volume of the outer cap, the threaded member having a threaded inner surface at a lower end and having a plurality of teeth at an upper end;
an inner cap positioned in the interior volume of the outer cap, the inner cap having a plurality of teeth at a lower end of the inner cap, wherein the inner cap is freely rotatable relative to the threaded member until a sufficient force is applied to the outer cap along a longitudinal axis, and the outer cap contacts the inner cap to cause the plurality of teeth of the inner cap to engage the plurality of teeth of the threaded member such that the threaded inner surface of the threaded member can selectively engage and disengage from a threaded outer surface of the container;
a pliable bulb at least partially positioned in the interior volume of the outer cap; and
a pipette in fluid communication with the pliable bulb, wherein the pliable bulb is compressible to move fluid out of the pipette and into the container, and the pliable bulb is expandable to move fluid from the container and into the pipette.

16. The cap system of claim 15, further comprising a button disposed about the pliable bulb, wherein movement of the button along the longitudinal axis in a first direction causes the pliable bulb to compress from a first volume to a second volume and move fluid out of the pipette and into the container.

17. The cap system of claim 16, wherein, in a manual mode of operation, a longitudinal force acts on the button to cause the button to move along the longitudinal axis in the first direction and move fluid out of the pipette and into the container.

18. The cap system of claim 16, wherein the button has a ridge extending from an outer surface, and the outer cap has a cam extending from an inner surface, wherein rotation of the outer cap about the longitudinal axis causes the cam to engage the ridge and the button to move along the longitudinal axis.

19. The cap system of claim 18, wherein, in an auto-loading mode of operation, a first longitudinal force acts on the outer cap to cause the plurality of teeth of the inner cap to engage the plurality of teeth of the threaded member, and a first rotational force acts on the outer cap to drive the cam into the ridge, move the button along the longitudinal axis in the first direction, and move fluid out of the pipette and into the container, and the first rotational force causes the threaded inner surface of the threaded member to engage the threaded outer surface of the container.

20. The cap system of claim 19, wherein, in the auto-loading mode of operation, a second longitudinal force acts on the outer cap to cause the plurality of teeth of the inner cap to engage the plurality of teeth of the threaded member, and a second rotational force acts on the outer cap to back the cam off of the ridge to allow the pliable bulb to expand, move the button along the longitudinal axis in a second direction, and move fluid from the container and into the pipette, and the second rotational force causes the threaded inner surface of the threaded member to disengage the threaded outer surface of the container.
